(19) United States
(12) Patent Application Publication
(10) Pub. No.: US 2011/0175943 A1
(43) Pub. Date: Jul. 21, 2011

(54) Gamma Voltage Output Circuit of Source Driver

(75) Inventors: Yong Sung Ahn, Ansan-si (KR); Jung Min Choi, Daejeon-si (KR)

(73) Assignee: SILICON WORKS CO., LTD, Daejeon-si (KR)

(21) Appl. No.: 13/008,332

(22) Filed: Jan. 18, 2011

(30) Foreign Application Priority Data
Jan. 19, 2010 (KR) 10-2010-0004661

(51) Int. Cl. G09G 5/10

(52) U.S. Cl. 345/690

(57) ABSTRACT

A gamma voltage output circuit of a source driver includes a reference voltage generation unit configured to generate upper and lower reference voltages; and upper and lower gamma buffers configured to stabilize and output the reference voltages. The lower gamma buffers include a first gamma buffer having a first operational amplifier which operates as a rail amplifier in a region between a positive power supply voltage and a ground voltage to receive a first lower reference voltage of a positive voltage region and output a first gamma voltage of the positive voltage region, and the upper gamma buffers include a second gamma buffer having a second operational amplifier which operates as a rail amplifier in a region between the ground voltage and a negative power supply voltage to receive a first upper reference voltage of a negative voltage region and output a second gamma voltage of the negative voltage region.

### BACKGROUND OF THE INVENTION

1. Field of the Invention

The present invention relates to a technology for outputting gamma voltages in a source driver of a display device, and more particularly, to a gamma voltage output circuit of a source driver, which can set a lower gamma voltage range to be the same as an upper gamma voltage range, when a negative power supply voltage is asymmetric with respect to a positive power supply voltage.

2. Description of the Related Art

In general, a display device has a source driver which drives data lines of a display panel according to R, G and B data inputted from an outside.

FIG. 1 is a block diagram illustrating a conventional source driver.

Referring to FIG. 1, a conventional source driver includes a reference voltage generation unit 11, a gamma buffer unit 12, a gamma voltage generation unit 13, an upper digital (D)/analog (A) converter 14A, a lower D/A converter 14B, a channel buffer unit 15, and an output multiplexer 16.

The reference voltage generation unit 11 has resistors R_r which are connected in series, and is configured to divide a voltage difference between an upper power supply voltage VPLVL and a lower power supply voltage VNLVL and generate a plurality of upper reference voltages VHref0 through VHref5 and a plurality of lower reference voltages VLref0 through VLref5.

The gamma buffer unit 12 has upper gamma buffers GB_VH1 through GB_VH6 and lower gamma buffers GB_VL1 through GB_VL6. The upper gamma buffers GB_VH1 through GB_VH6 are configured to stabilize and output the upper reference voltages VHref0 through VHref5 which are outputted from the reference voltage generation unit 11, and the lower gamma buffers GB_VL1 through GB_VL6 are configured to stabilize and output the lower reference voltages VLref0 through VLref5 which are outputted from the reference voltage generation unit 11.

The gamma voltage generation unit 13 has resistors R_s which are connected in series, and is configured to divide the upper reference voltages VHref0 through VHref5 which are outputted from the gamma buffer unit 12 and output upper gamma voltages VH_G[0] through VH_G[255], and to divide the lower reference voltages VLref0 through VLref5 which are outputted from the gamma buffer unit 12 and output lower gamma voltages VL_G[0] through VL_G[255].

The upper D/A converter 14A and the lower D/A converter 14B are configured to output the upper gamma voltages VH_G[0] through VH_G[255] and the lower gamma voltages VL_G[0] through VL_G[255] in correspondence to the R, G and B data which are inputted from a controller (for example, a timing controller).

The channel buffer unit 15 has an upper channel buffer CB_VH, a lower channel buffer CB_VL, and a virtual ground channel buffer CB_VG. The upper channel buffer CB_VH is configured to stabilize and output the upper gamma voltages VH_G[0] through VH_G[255] which are outputted from the upper D/A converter 14A. The lower channel buffer CB_VL is configured to stabilize and output the lower gamma voltages VL_G[0] through VL_G[255] which are outputted from the lower D/A converter 14B. The virtual ground channel buffer CB_VG is configured to average the last upper gamma voltage VH_G[255] and the first lower gamma voltage VL_G[255] which are outputted from the gamma voltage generation unit 13, and output a stabilized virtual ground voltage VG.

The output multiplexer 16 is configured to selectively output the upper gamma voltages VH_G[0] through VH_G[255] and the lower gamma voltages VL_G[0] through VL_G[255] which are outputted from the upper channel buffer CB_VH and the lower channel buffer CB_VL.

FIG. 2 shows relationships among a positive power supply voltage VSP, a negative power supply voltage VSN, a positive voltage region ‘positive region’, a negative voltage region ‘negative region’, an upper gamma voltage range ‘VH Gamma range’, and a lower gamma voltage range ‘VL Gamma range’, which are used in the source driver shown in FIG. 1. FIG. 2 represents a case in which the absolute value of the positive power supply voltage VSP is larger than the absolute value of the negative power supply voltage VSN.

Ideally, the positive voltage region ‘positive region’ and the negative voltage region ‘negative region’ should be symmetric to each other. However, since the positive power supply voltage VSP actually used in a display device is larger in absolute value than the negative power supply voltage VSN, the positive voltage region ‘positive region’ and the negative voltage region ‘negative region’ become asymmetric to each other.

A switch mode power supply unit for supplying voltages to the source driver of the display device generates the positive power supply voltage VSP and produces the positive power supply voltage VSP as the negative power supply voltage VSN using a negative charge pumping circuit.

Therefore, the positive power supply voltage VSP supplied to the source driver has an absolute value larger than that of the negative power supply voltage VSN, and as a result, the positive power supply voltage VSP and the negative power supply voltage VSN, which are asymmetric to each other when viewed in the light of the ground voltage GND, are supplied to the source driver.

Due to this fact, as can be readily seen from FIG. 2, the ground voltage GND is positioned over the upper end of the lower gamma voltage range ‘VL Gamma range’, and the positive voltage region ‘positive region’ occupies the entire upper gamma voltage range ‘VH Gamma range’ and a portion of the lower gamma voltage range ‘VL Gamma range’.

In this case, the lower reference voltage VLref0, which belongs to the positive voltage region ‘positive region’, is inputted to the input stage of the first lower gamma buffer GB_VL1 which outputs the lower gamma voltage VL_G[255]. The virtual ground channel buffer CB_VG averages the upper reference voltage VHref5 which belongs to the positive voltage region ‘positive region’ and the lower reference voltage VLref0 which belongs to the positive voltage region ‘positive region’, and generates the virtual ground voltage VG which belongs to the positive voltage region ‘positive region’.

Because the upper end of the lower gamma voltage range ‘VL Gamma range’ is positioned between the virtual ground voltage VG and the ground voltage GND, the lower gamma voltage at the upper end of the lower gamma voltage range ‘VL Gamma range’, for example, the first lower gamma voltage VL_G[255] should be a gamma voltage which belongs to the positive voltage region ‘positive region’. However, since the lower gamma buffers GB_VL1 through GB_VL6 according to the conventional art output the lower gamma voltages VL_G[0] through VL_G[255] using the ground voltage GND and the negative power supply voltage VSN, they cannot output gamma voltages which belong to the positive voltage region ‘positive region’. Hence, if the upper gamma voltage range and the lower gamma voltage range are set to be symmetric to each other, a gamma voltage range capable of being used is narrowed.

Such a problem may be similarly caused in the case where the absolute value of the positive power supply voltage VSP is smaller than the absolute value of the negative power supply voltage VSN as shown in FIG. 3. Referring to FIG. 3, since the lower end of the upper gamma voltage range ‘VH Gamma range’ is positioned between the virtual ground voltage VG and the ground voltage GND, the upper gamma voltage at the lower end of the upper gamma voltage range ‘VH Gamma range’, for example, the last upper gamma voltage VH_G[255] should be a gamma voltage which belongs to the negative voltage region ‘negative region’. Since the upper gamma buffers GB_VH1 through GB_VH6 according to the conventional art output the upper gamma voltages VH_G[0] through VH_G[255] using the ground voltage GND and the positive power supply voltage VSP, they cannot output gamma voltages which belong to the negative voltage region ‘negative region’.

As a consequence, if the upper gamma voltage range and the lower gamma voltage range are set to be symmetric to each other, a gamma voltage range capable of being used is likely to be narrowed, which is problematic.

### SUMMARY OF THE INVENTION

Accordingly, the present invention has been made in an effort to solve the problems occurring in the related art, and an object of the present invention is to provide a gamma voltage output circuit in which gamma buffers disposed in boundary regions of an upper gamma voltage range and a lower gamma voltage range include a gamma buffer capable of operating by a positive power supply voltage and a ground voltage or a gamma buffer capable of operating by a ground voltage or a negative power supply voltage so that the gamma buffer can selectively operate when the positive power supply voltage and the negative power supply voltage are asymmetric in a source driver of a display device.

The present invention is not limited to such an object. Other objects and advantages of the present invention will be more apparently understood from the following descriptions.

In order to achieve the above object, according to one aspect of the present invention, there is provided a gamma voltage output circuit of a source driver, including: a reference voltage generation unit configured to divide a voltage difference between an upper power supply voltage and a lower power supply voltage using serial resistors, and generate upper reference voltages and lower reference voltages; and upper gamma buffers configured to stabilize and output the upper reference voltages, and lower gamma buffers configured to stabilize and output the lower reference voltages, wherein the lower gamma buffers include a first gamma buffer having a first operational amplifier which operates as a rail amplifier in a region between a positive power supply voltage and a ground voltage so as to receive a first lower reference voltage of a positive voltage region and output a first gamma voltage of the positive voltage region, and wherein the upper gamma buffers include a second gamma buffer having a second operational amplifier which operates as a rail amplifier in a region between the ground voltage and a negative power supply voltage so as to receive a first upper reference voltage of a negative voltage region and output a second gamma voltage of the negative voltage region.

In order to achieve the above object, according to another aspect of the present invention, there is provided a gamma voltage output circuit of a source driver, supplied with power supply voltages in which absolute values of a positive power supply voltage and a negative power supply voltage are asymmetric, including: a reference voltage generation unit configured to generate upper reference voltages and lower reference voltages; and upper gamma buffers configured to stabilize and output the upper reference voltages, and lower gamma buffers configured to stabilize and output the lower reference voltages, wherein the lower gamma buffers include at least one first gamma buffer which receives a first lower reference voltage of a positive voltage region and outputs a first gamma voltage of the positive voltage region, and wherein the upper gamma buffers include at least one second gamma buffer which receives a first upper reference voltage of a negative voltage region and outputs a second gamma voltage of the negative voltage region.

### BRIEF DESCRIPTION OF THE DRAWINGS

The above object, and other features and advantages of the present invention will become more apparent after a reading of the following detailed description taken in conjunction with the drawings, in which:

FIG. 1 is a block diagram illustrating a conventional source driver;

FIG. 2 is a diagram explaining relationships between the ranges of various voltages used in a source driver when the absolute value of a positive power supply voltage is larger than the absolute value of a negative power supply voltage;

FIG. 3 is a diagram explaining relationships between the ranges of various voltages used in a source driver when the absolute value of a positive power supply voltage is smaller than the absolute value of a negative power supply voltage;

FIG. 4 is a block diagram illustrating a gamma voltage output circuit of a source driver in accordance with an embodiment of the present invention;

FIG. 5 is a block diagram illustrating a gamma voltage output circuit of a source driver in accordance with another embodiment of the present invention;

FIG. 6 is a circuit diagram illustrating one embodiment of the first lower gamma buffer shown in FIG. 4 and the sixth upper gamma buffer shown in FIG. 5;

FIG. 7 is a circuit diagram illustrating another embodiment of the first lower gamma buffer shown in FIG. 4 and the sixth upper gamma buffer shown in FIG. 5; and

FIG. 8 is a circuit diagram illustrating still another embodiment of the first lower gamma buffer shown in FIG. 4 and the sixth upper gamma buffer shown in FIG. 5.

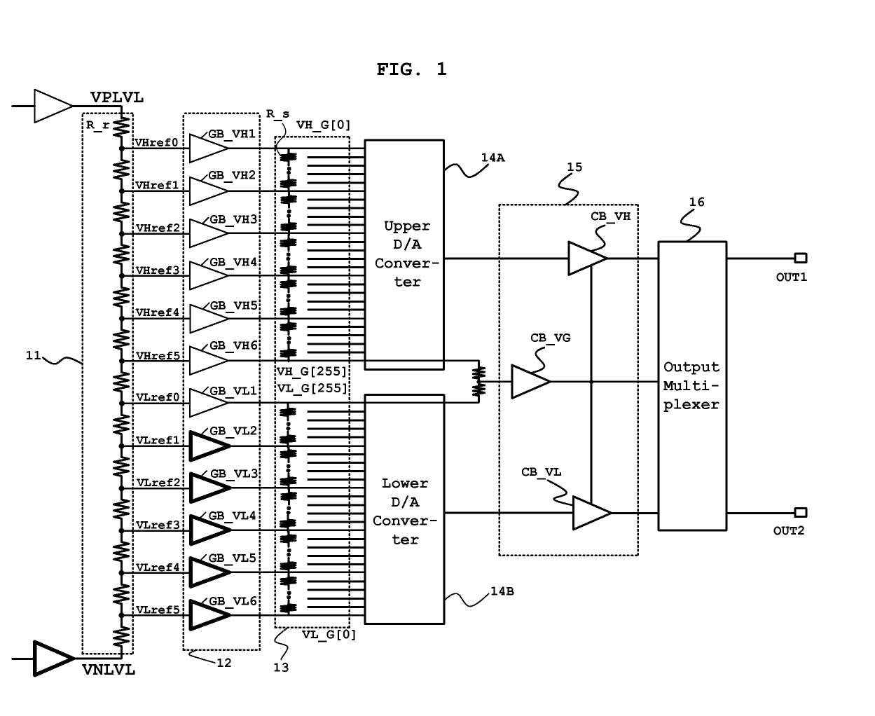

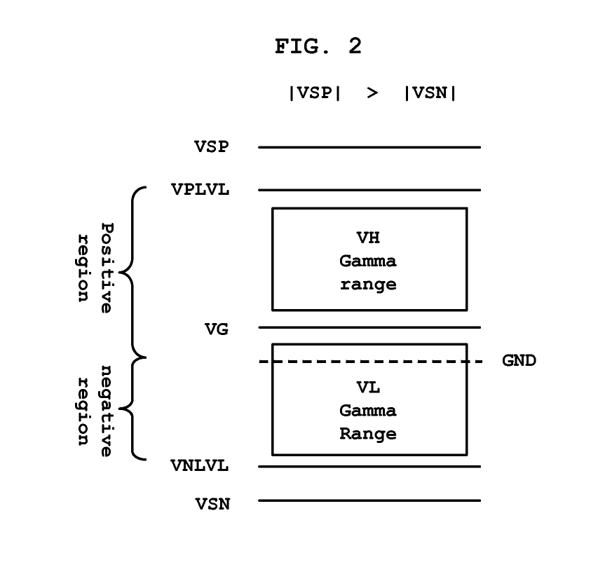

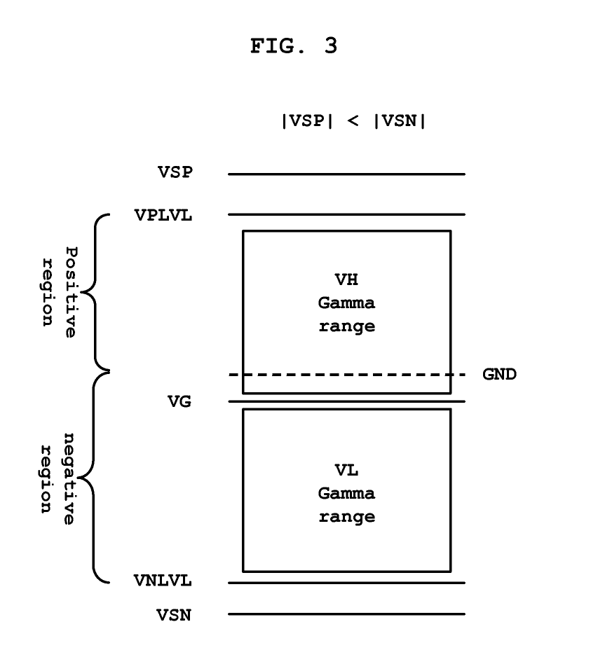

### DETAILED DESCRIPTION OF PREFERRED EMBODIMENTS

Reference will now be made in greater detail to preferred embodiments of the invention, examples of which are illustrated in the accompanying drawings. The numerical or ordinal words, such as first, second, and so forth, used in the course of describing the preferred embodiments of the present invention are nothing but identifiers for distinguishing individuals from one another.

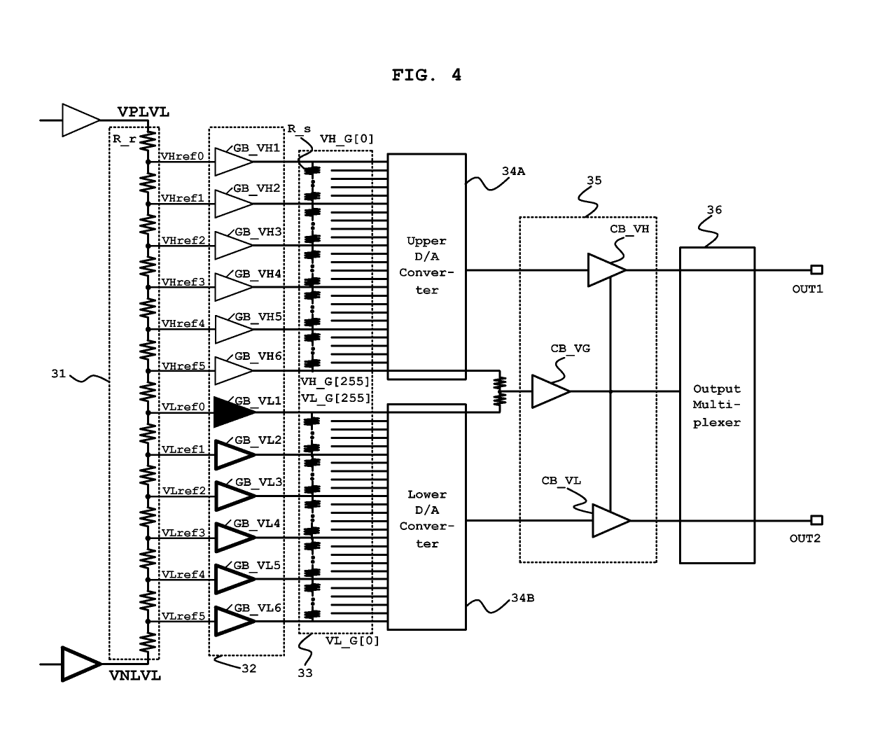

FIG. 4 is a block diagram illustrating a gamma voltage output circuit of a source driver in accordance with an embodiment of the present invention.

Referring to FIG. 4, the gamma voltage output circuit of a source driver in accordance with the embodiment of the present invention includes a reference voltage generation unit 31, a gamma buffer unit 32, a gamma voltage generation unit 33, an upper digital (D)/analog (A) converter 34A, a lower D/A converter 34B, a channel buffer unit 35, and an output multiplexer 36.

The reference voltage generation unit 31 has resistors R_r which are connected in series, and is configured to divide a voltage difference between an upper power supply voltage VPLVL and a lower power supply voltage VNLVL and generate first through sixth upper reference voltages VHref0 through VHref5 and first through sixth lower reference voltages VLref0 through VLref5. The upper power supply voltage VPLVL is a most significant voltage which is applied to the resistors R_r connected in series and is a stable voltage which is obtained by removing noise from a positive power supply voltage VSP. The lower power supply voltage VNLVL is a least significant voltage which is applied to the resistors R_r connected in series and is a stable voltage which is obtained by removing noise from a negative power supply voltage VSN.

The gamma buffer unit 32 includes first through sixth upper gamma buffers GB_VH1 through GB_VH6 and first through sixth lower gamma buffers GB_VL1 through GB_VL6. The first through sixth upper gamma buffers GB_VH1 through GB_VH6 are configured to stabilize and output the first through sixth upper reference voltages VHref0 through VHref5 which are outputted from the reference voltage generation unit 31. The first through sixth lower gamma buffers GB_VL1 through GB_VL6 are configured to stabilize and output the first through sixth lower reference voltages VLref0 through VLref5 which are outputted from the reference voltage generation unit 31.

The first through sixth upper gamma buffers GB_VH1 through GB_VH6 operate as rail amplifiers in a region between the positive power supply voltage VSP and the ground voltage GND, and the second through sixth lower gamma buffers GB_VL2 through GB_VL6 operate as rail amplifiers in a region between the ground voltage GND and the negative power supply voltage VSN. The first lower gamma buffer GB_VL1 can operate as a rail amplifier in a region between the positive power supply voltage VSP and the negative power supply voltage VSN. In the present embodiment, the first lower gamma buffer GB_VL1 is a first lower gamma buffer which outputs a most significant voltage among the lower gamma buffers GB_VL1 through GB_VL6, and is exemplified as a gamma buffer which operates adjacent to the boundary regions of an upper gamma voltage range and a lower gamma voltage range.

The gamma voltage generation unit 33 has resistors R_s which are connected in series. The gamma voltage generation unit 33 is configured to divide the first through sixth upper reference voltages VHref0 through VHref5 outputted from the gamma buffer unit 32 and output first through two hundred fifty sixth upper gamma voltages VH_G[0] through VH_G[255], and to divide the first through sixth lower reference voltages VLref0 through VLref5 outputted from the gamma buffer unit 32 and output first through two hundred fifty sixth lower gamma voltages VL_G[0] through VL_G[255].

The upper D/A converter 34A is configured to output the first through two hundred fifty sixth upper gamma voltages VH_G[0] through VH_G[255] in correspondence to the R, G and B data which are inputted from a controller. The lower D/A converter 34B is configured to output the first through two hundred fifty sixth lower gamma voltages VL_G[255] through VL_G[0] in correspondence to the R, G and B data which are inputted from the controller.

The channel buffer unit 35 includes an upper channel buffer CB_VH, a lower channel buffer CB_VL, and a virtual ground channel buffer CB_VG. The upper channel buffer CB_VH is configured to stabilize and output the first through two hundred fifty sixth upper gamma voltages VH_G[0] through VH_G[255] which are outputted from the upper D/A converter 34A. The lower channel buffer CB_VL is configured to stabilize and output the first through two hundred fifty sixth lower gamma voltages VL_G[255] through VL_G[0] which are outputted from the lower D/A converter 34B.

The virtual ground channel buffer CB_VG is configured to average the two hundred fifty sixth upper gamma voltage VH_G[255] and the first lower gamma voltage VL_G[255], which are outputted from the gamma voltage generation unit 33, and output a stabilized virtual ground voltage VG. The upper gamma voltage range and the lower gamma voltage range may be determined based on the virtual ground voltage VG in such a way as to be symmetric to each other. In the present embodiment, the two hundred fifty sixth upper gamma voltage VH_G[255] is exemplified as a last upper gamma voltage, and the first lower gamma voltage VL_G[255] is exemplified as a first lower gamma voltage.

The output multiplexer 36 is configured to selectively output the first through two hundred fifty sixth upper gamma voltages VH_G[0] through VH_G[255] and the first through two hundred fifty sixth lower gamma voltages VL_G[255] through VL_G[0] which are outputted from the upper channel buffer CB_VH and the lower channel buffer CB_VL.

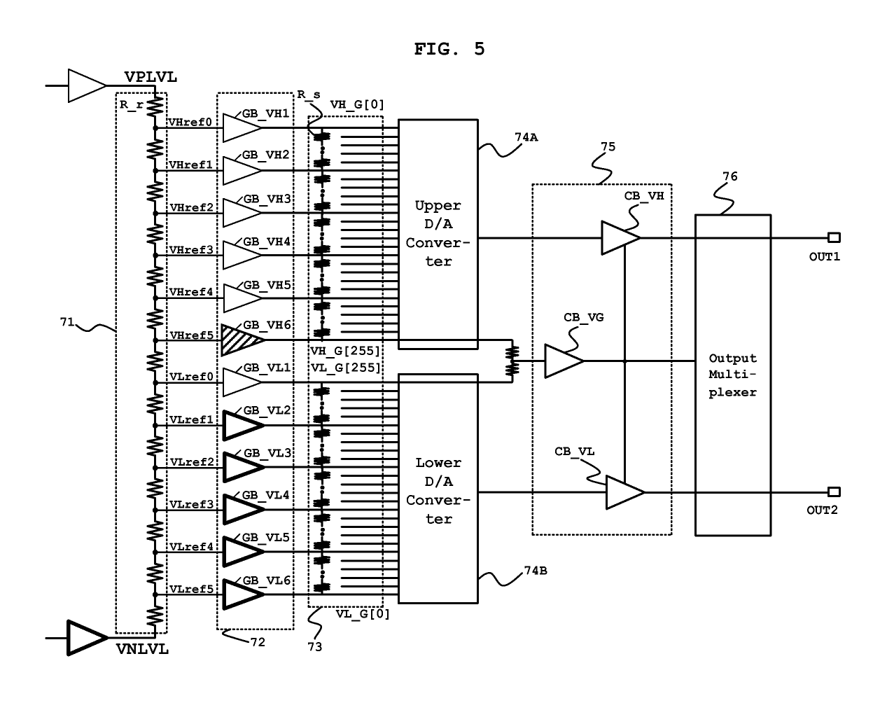

FIG. 5 is a block diagram illustrating a gamma voltage output circuit of a source driver in accordance with another embodiment of the present invention.

Referring to FIG. 5, the gamma voltage output circuit of a source driver in accordance with another embodiment of the present invention includes a reference voltage generation unit 71, a gamma buffer unit 72, a gamma voltage generation unit 73, an upper D/A converter 74A, a lower D/A converter 74B, a channel buffer unit 75, and an output multiplexer 76.

The gamma buffer unit 72 includes first through sixth upper gamma buffers GB_VH1 through GB_VH6 and first through sixth lower gamma buffers GB_VL1 through GB_VL6. The first through fifth upper gamma buffers GB_VH1 through GB_VH5 operate as rail amplifiers in a region between a positive power supply voltage VSP and a ground voltage GND, and the first through sixth lower gamma buffers GB_VL1 through GB_VL6 operate as rail amplifiers in a region between the ground voltage GND and a negative power supply voltage VSN. The sixth upper gamma buffer GB_VH6 can operate as a rail amplifier in a region between the positive power supply voltage VSP and the negative power supply voltage VSN. In the present embodiment, the sixth upper gamma buffer GB_VH6 is a last upper gamma buffer which outputs a least significant voltage among the upper gamma buffers GB_VH1 through GB_VH6, and is exemplified as a gamma buffer which operates adjacent to the boundary regions of an upper gamma voltage range and a lower gamma voltage range.

Since the configurations and operations of the reference voltage generation unit 71, the gamma voltage generation unit 73, the upper D/A converter 74A, the lower D/A converter 74B, the channel buffer unit 75, and the output multiplexer 76 can be easily understood by a person skilled in the art from the descriptions for the gamma voltage output circuit of a source driver shown in FIG. 4, detailed descriptions thereof will be omitted herein.

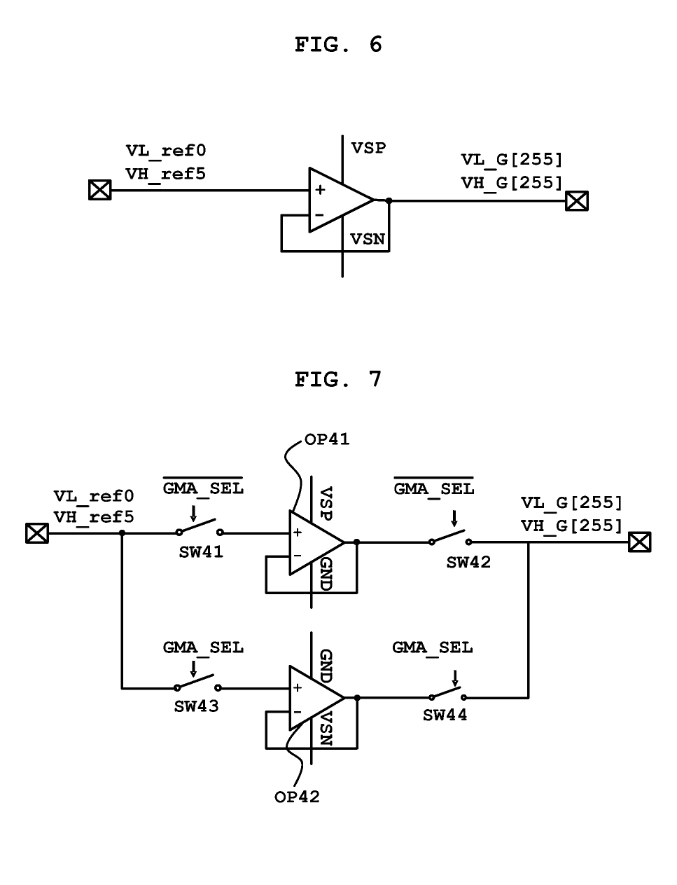

FIG. 6 is a circuit diagram illustrating one embodiment of the first lower gamma buffer shown in FIG. 4 and the sixth upper gamma buffer shown in FIG. 5.

Referring to FIG. 6, the first lower gamma buffer GB_VL1 shown in FIG. 4 is a rail amplifier which operates in the region between the positive power supply voltage VSP and the negative power supply voltage VSN. The first lower gamma buffer GB_VL1 may be an operational amplifier which receives the positive power supply voltage VSP and the negative power supply voltage VSN as power supply voltages and has a non-inverting input terminal + to receive the first lower reference voltage VLref0 and an inverting input terminal − to be connected to an output terminal, the output terminal outputting the first lower gamma voltage VL_G[255] to a corresponding resistor among the resistors R_s, connected in series, of the gamma voltage generation unit 33.

In the case where the absolute value of the positive power supply voltage VSP is larger than the absolute value of the negative power supply voltage VSN, the lower reference voltage VLref0, which belongs to a positive voltage region, is inputted to the input stage of the first lower gamma buffer GB_VL1. Since the first lower gamma buffer GB_VL1 is a rail amplifier which operates in the region between the positive power supply voltage VSP and the negative power supply voltage VSN, even when the lower reference voltage VLref0 which belongs to the positive voltage region is inputted, the first lower gamma buffer GB_VL1 can buffer the lower reference voltage VLref0 and output a gamma voltage which belongs to the positive voltage region.

Referring to FIG. 6, the sixth upper gamma buffer GB_VH6 shown in FIG. 5 is a rail amplifier which operates in the region between the positive power supply voltage VSP and the negative power supply voltage VSN. The sixth upper gamma buffer GB_VH6 may be an operational amplifier which receives the positive power supply voltage VSP and the negative power supply voltage VSN as power supply voltages and has a non-inverting input terminal + to receive the sixth upper reference voltage VHref5 and an inverting input terminal − to be connected to an output terminal, the output terminal outputting the two hundred fifty sixth upper gamma voltage VH_G[255] to a corresponding resistor among the resistors R_s, connected in series, of the gamma voltage generation unit 33.

In the case where the absolute value of the positive power supply voltage VSP is smaller than the absolute value of the negative power supply voltage VSN, the upper reference voltage VHref5, which belongs to a negative voltage region, is inputted to the input pad of the sixth upper gamma buffer GB_VH6. Since the sixth lower gamma buffer GB_VH6 is a rail amplifier which operates in the region between the positive power supply voltage VSP and the negative power supply voltage VSN, even when the upper reference voltage VHref5 which belongs to the negative voltage region is inputted, the sixth upper gamma buffer GB_VH6 can buffer the upper reference voltage VHref5 and output a gamma voltage which belongs to the negative voltage region.

FIG. 7 is a circuit diagram illustrating another embodiment of the first lower gamma buffer shown in FIG. 4 and the sixth upper gamma buffer shown in FIG. 5.

Referring to FIG. 7, the first lower gamma buffer GB_VL1 and the sixth upper gamma buffer GB_VH6 include a first operational amplifier OP41 which operates as a rail amplifier in the region between the positive power supply voltage VSP and the ground voltage GND to receive the lower reference voltage VLref0 of the positive voltage region and output the gamma voltage VL_G[255] of the positive voltage region, a first switch SW41 which controls connection of an input pad and the non-inverting terminal + of the first operational amplifier OP41 in response to a gamma select bar signal GMA_SEL_B, a second switch SW42 which controls connection of an output pad and the first output terminal of the first operational amplifier OP41 in response to the gamma select bar signal GMA_SEL_B, a second operational amplifier OP42 which operates as a rail amplifier in the region between the ground voltage GND and the negative power supply voltage VSN to receive the upper reference voltage VHref5 of the negative voltage region and output the gamma voltage VH_G[255] of the negative voltage region, a third switch SW43 which controls connection of the input pad and the non-inverting terminal + of the second operational amplifier OP42 in response to a gamma select signal GMA_SEL, and a fourth switch SW44 which controls connection of the output pad and the output terminal of the second operational amplifier OP42 in response to the gamma select signal GMA_SEL. It is preferred that each of the first operational amplifier OP41 and the second operational amplifier OP42 is an operational amplifier in which an output terminal is connected to an inverting input terminal −.

The gamma select signal GMA_SEL is a signal which is changed in the logic state thereof depending upon a polarity of the voltage inputted to each of the first lower gamma buffer GB_VL1 of FIG. 4 and the sixth upper gamma buffer GB_VH6 of FIG. 5. If the reference voltages inputted to the first lower gamma buffer GB_VL1 of FIG. 4 and the sixth upper gamma buffer GB_VH6 of FIG. 5 are reference voltages of the positive voltage region in the region between the positive power supply voltage VSP and the ground voltage GND, the gamma select signal GMA_SEL is disabled to a low level, and if the reference voltages inputted to the first lower gamma buffer GB_VL1 of FIG. 4 and the sixth upper gamma buffer GB_VH6 of FIG. 5 are reference voltages of the negative voltage region in the region between ground voltage GND and the negative power supply voltage VSN, the gamma select signal GMA_SEL is enabled to a high level. The gamma select bar signal GMA_SEL_B is a signal which has a logic state opposite to that of the gamma select signal GMA_SEL.

For example, if the absolute value of the positive power supply voltage VSP is larger than the absolute value of the negative power supply voltage VSN (|VSP|>|VSN|), the first lower reference voltage VLref0 equal to or larger than the ground voltage GND, that is, belonging to the positive voltage region, may be inputted to the input pad of the first lower gamma buffer GB_VL1.

At this time, the controller outputs the gamma select bar signal GMA_SEL_B of the high level and turns on the first switch SW41 and the second switch SW42, and outputs the gamma select signal GMA_SEL of the low level and turns off the third switch SW43 and the fourth switch SW44. Accordingly, the first operational amplifier OP41 of the first lower gamma buffer GB_VL1 receives and stabilizes the first lower reference voltage VLref0 of the positive voltage region and outputs the first lower gamma voltage VL_G[255].

If the absolute value of the positive power supply voltage VSP is smaller than the absolute value of the negative power supply voltage VSN (|VSP|<|VSN|), the sixth upper reference voltage VHref5 equal to or smaller than the ground voltage GND, that is, belonging to the negative voltage region, may be inputted to the input stage of the sixth upper gamma buffer GB_VH6.

At this time, the controller outputs the gamma select signal GMA_SEL of the high level and turns off the first switch SW41 and the second switch SW42, and outputs the gamma select bar signal GMA_SEL_B of the low level and turns on the third switch SW43 and the fourth switch SW44. Accordingly, the second operational amplifier OP42 of the sixth upper gamma buffer GB_VH6 receives and stabilizes the sixth upper reference voltage VHref5 of the negative voltage region and outputs the last upper gamma voltage VH_G[255].

According to the present embodiment, when the absolute value of the positive power supply voltage VSP and the absolute value of the negative power supply voltage VSN are asymmetric to each other (|VSP|>|VSN| or |VSP|<|VSN|), the gamma buffers which operate adjacent to the boundary regions of the upper gamma voltage range and the lower gamma voltage range, for example, the sixth upper gamma buffer GB_VH6 and the first lower gamma buffer GB_VL1 can be selectively operated in the region between the positive power supply voltage VSP and the ground voltage GND or in the region between the ground voltage GND and the negative power supply voltage VSN according to the gamma select signal GAM_SEL. As a consequence, when symmetrically setting a lower gamma voltage range ‘VL Gamma range’ and an upper gamma voltage range ‘VH Gamma range’, a gamma voltage range can be widely used.

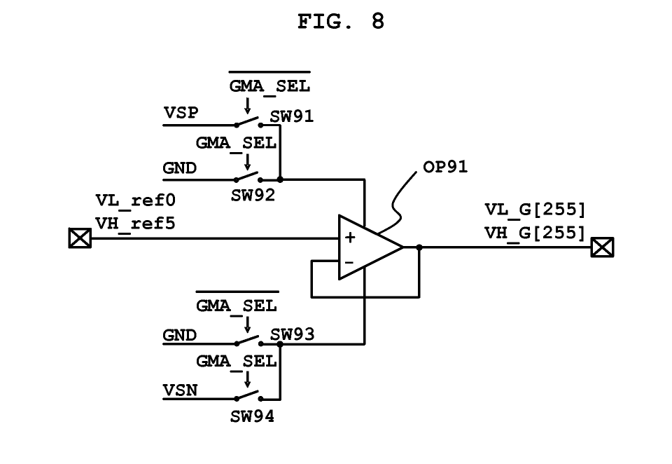

FIG. 8 is a circuit diagram illustrating still another embodiment of the first lower gamma buffer shown in FIG. 4 and the sixth upper gamma buffer shown in FIG. 5.

Referring to FIG. 8, the first lower gamma buffer GB_VL1 and the sixth upper gamma buffer GB_VH6 include a third operational amplifier OP91 which has a non-inverting input terminal + to be connected with an input pad, an inverting input terminal − to be connected with an output terminal and the output terminal to be connected with an output pad, a fifth switch SW91 and a seventh switch SW93 which control supply of the positive power supply voltage VSP and the ground voltage GND to the third operational amplifier OP91 in response to a gamma select bar signal GMA_SEL_B, and a sixth switch SW92 and an eighth switch SW94 which control supply of the ground voltage GND and the negative power supply voltage VSN to the third operational amplifier OP91 in response to the gamma select signal GMA_SEL.

If the absolute value of the positive power supply voltage VSP is larger than the absolute value of the negative power supply voltage VSN (|VSP|>|VSN|), the first lower reference voltage VLref0 equal to or larger than the ground voltage GND, that is, belonging to the positive voltage region, may be inputted to the input pad of the first lower gamma buffer GB_VL1.

At this time, the controller outputs the gamma select bar signal GMA_SEL_B of the high level and turns on the fifth switch SW91 and the seventh switch SW93, and outputs the gamma select signal GMA_SEL of the low level and turns off the sixth switch SW92 and the eighth switch SW94. Accordingly, the positive power supply voltage VSP and the ground voltage GND are supplied as power supply voltages to the third operational amplifier OP91 of the first lower gamma buffer GB_VL1 through the fifth switch SW91 and the seventh switch SW93. Due to this fact, the third operational amplifier OP91 of the first lower gamma buffer GB_VL1 can receive and stabilize the first lower reference voltage VLref0 of the positive voltage region and output the first lower gamma voltage VL_G[255].

If the absolute value of the positive power supply voltage VSP is smaller than the absolute value of the negative power supply voltage VSN (|VSP|<|VSN|), the sixth upper reference voltage VHref5 equal to or smaller than the ground voltage GND, that is, belonging to the negative voltage region, is inputted to the input pad of the sixth upper gamma buffer GB_VH6.

At this time, the controller outputs the gamma select signal GMA_SEL of the high level and turns off the fifth switch SW91 and the seventh switch SW93, and outputs the gamma select bar signal GMA_SEL_B of the low level and turns on the sixth switch SW92 and the eighth switch SW94. Accordingly, the ground voltage GND and the negative power supply voltage VSN are supplied as power supply voltages to the third operational amplifier OP91 of the sixth upper gamma buffer GB_VH6 through the sixth switch SW92 and the eighth switch SW94. Due to this fact, the third operational amplifier OP91 of the sixth upper gamma buffer GB_VH6 can receive and stabilize the sixth upper reference voltage VHref5 of the negative voltage region and output the last upper gamma voltage VH_G[255].

In the present embodiment, when the absolute value of the positive power supply voltage VSP and the absolute value of the negative power supply voltage VSN are asymmetric to each other (|VSP|>|VSN| or |VSP|<|VSN|), although the sixth upper gamma buffer GB_VH6 and the first lower gamma buffer GB_VL1 were exemplarily explained as gamma buffers which operate adjacent to the boundary regions of the upper gamma voltage range and the lower gamma voltage range, gamma buffers, which selectively operate in the region between the positive power supply voltage VSP and the ground voltage GND or in the region between the ground voltage GND and the negative power supply voltage VSN according to the a gamma select signal, are not limited to such gamma buffers and, for example, can be extensively applied to the fifth upper gamma buffer GB_VH5 and the second lower gamma buffer GB_VL2.

Because a gamma voltage range can be widely used when symmetrically setting a lower gamma voltage range ‘VL Gamma range’ and an upper gamma voltage range ‘VH Gamma range’, the gamma voltage output circuit of a source driver in accordance with the present embodiment of the invention can be used in a liquid crystal display panel which adopts an in-plane switching (IPS) mode or a vertical alignment (VA) mode requiring a wide gamma voltage range. However, the gamma voltage output circuit of a source driver in accordance with the present embodiment of the invention is not limited to a liquid crystal display panel, and may be applied to other flat panel displays (FPDs) such as an organic light emitting diode (OLED).

As is apparent from the above description, in the embodiments of the present invention, in the case where the absolute values of a negative power supply voltage and a positive power supply voltage are asymmetric to each other, gamma buffers capable of operating in the boundary regions of an upper gamma voltage range and a lower gamma voltage range are enabled to operate between the positive power supply voltage and the negative power supply voltage. Therefore, when setting a lower gamma voltage range to be symmetric to an upper gamma voltage range, a gamma voltage range can be widely used.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A gamma voltage output circuit of a source driver, comprising:
a reference voltage generation unit configured to divide a voltage difference between an upper power supply voltage and a lower power supply voltage using serial resistors, and generate upper reference voltages and lower reference voltages; and
upper gamma buffers configured to stabilize and output the upper reference voltages, and lower gamma buffers configured to stabilize and output the lower reference voltages,
wherein the lower gamma buffers include a first gamma buffer having a first operational amplifier which operates as a rail amplifier in a region between a positive power supply voltage and a ground voltage so as to receive a first lower reference voltage of a positive voltage region and output a first gamma voltage of the positive voltage region.

2. The gamma voltage output circuit according to claim 1, wherein the first lower gamma buffer includes a first switch and a second switch which are respectively connected to input and output terminals of the first operational amplifier, to select the first operational amplifier when a range of the positive voltage region is wider than a range of a negative voltage region.

3. The gamma voltage output circuit according to claim 1, wherein the upper gamma buffers include a second gamma buffer having a second operational amplifier which operates as a rail amplifier in a region between the ground voltage and a negative power supply voltage so as to receive a first upper reference voltage of a negative voltage region and output a second gamma voltage of the negative voltage region.

4. The gamma voltage output circuit according to claim 3, wherein the sixth upper gamma buffer includes a third switch and a fourth switch which are respectively connected to input and output terminals of the second operational amplifier, to select the second operational amplifier when the range of the negative voltage region is wider than the range of the positive voltage region.

5. A gamma voltage output circuit of a source driver, supplied with power supply voltages in which absolute values of a positive power supply voltage and a negative power supply voltage are asymmetric, comprising:
a reference voltage generation unit configured to generate upper reference voltages and lower reference voltages; and
upper gamma buffers configured to stabilize and output the upper reference voltages, and lower gamma buffers configured to stabilize and output the lower reference voltages,
wherein the lower gamma buffers include at least one first gamma buffer which receives a first lower reference voltage of a positive voltage region and outputs a first gamma voltage of the positive voltage region.

6. The gamma voltage output circuit according to claim 5, wherein the upper gamma buffers include at least one second gamma buffer which receives a first upper reference voltage of a negative voltage region and outputs a second gamma voltage of the negative voltage region.

7. The gamma voltage output circuit according to claim 6, wherein the first gamma buffer and the second gamma buffer include operational amplifiers which operate in regions of the positive power supply voltage and the negative power supply voltage.

8. The gamma voltage output circuit according to claim 6, wherein the first gamma buffer and the second gamma buffer comprise:
a first operational amplifier configured to operate as a rail amplifier in a region between the positive power supply voltage and a ground voltage so as to receive the first lower reference voltage and output the first gamma voltage;
a first switch configured to control connection of an input pad and a non-inverting terminal of the first operational amplifier in response to a gamma select bar signal;
a second switch configured to control connection of an output pad and an output terminal of the first operational amplifier in response to the gamma select bar signal;
a second operational amplifier configured to operate as a rail amplifier in a region between the ground voltage and the negative power supply voltage so as to receive the first upper reference voltage and output the second gamma voltage;
a third switch configured to control connection of the input pad and a non-inverting terminal of the second operational amplifier in response to a gamma select signal; and
a fourth switch configured to control connection of the output pad and an output terminal of the second operational amplifier in response to the gamma select signal.

9. The gamma voltage output circuit according to claim 8, wherein the gamma select signal is enabled when the first lower reference voltage is inputted to the input pad and is disabled when the first upper reference voltage is inputted to the input pad, and has a logic state opposite to that of the gamma select bar signal.

10. The gamma voltage output circuit according to claim 6, wherein the first gamma buffer and the second gamma buffer comprise:
a third operational amplifier having a non-inverting input terminal to which an input pad is connected, an inverting input terminal to which an output terminal is connected, and the output terminal which is connected to an output pad;
a fifth switch and a sixth switch configured to control supply of the positive power supply voltage and the ground voltage to the third operational amplifier in response to a gamma select bar signal; and
a seventh switch and an eighth switch configured to control supply of the ground voltage and the negative power supply voltage to the third operational amplifier in response to a gamma select signal.

11. The gamma voltage output circuit according to claim 10, wherein the gamma select signal is enabled when the first lower reference voltage is inputted to the input pad and is disabled when the first upper reference voltage is inputted to the input pad, and has a logic state opposite to that of the gamma select bar signal.
